(19) United States
(12) Patent Application Publication
(10) Pub. No.: US 2017/0307382 A1
(43) Pub. Date: Oct. 26, 2017

(54) ROUTE GUIDANCE METHOD AND DEVICE FOR AUDIENCE IN EXHIBITION HALL BY MEANS OF VISIBLE LIGHT COMMUNICATION

(71) Applicant: YUYANG DNU CO., LTD., Hwaseong-si, Gyeonggi-do (KR)

(72) Inventors: Sangok KIM, Seoul (KR); Byungoh KIM, Suwon-si (KR); Dongsik KIM, Hwaseong-si (KR)

(21) Appl. No.: 15/510,964

(22) PCT Filed: Sep. 17, 2014
(86) PCT No.: PCT/KR2014/008651

§ 371 Date: Mar. 13, 2017

(30) Foreign Application Priority Data
Sep. 15, 2014 (KR) 10-2014-0122285

(51) Int. Cl. G01C 21/20; H04B 10/116; G06Q 90/00

(52) U.S. Cl. CPC G01C 21/206; H04B 10/116; G06Q 90/20

(57) ABSTRACT

The present disclosure in some embodiments provides a route guidance method and apparatus for visitors in a venue using visible light communication, which generates recommended routes that pass through at least one common point of interest starting from current locations based on a guidance information received from a visible-light illumination device installed in the venue and an information on a current distribution of the visitors at respective places in the venue, and thereby allows the visitors to view exhibits more efficiently, while offering a positive guidance for the visitors to view some exhibits or one-off shows which might otherwise be missed out.

### TECHNICAL FIELD

The present disclosure in some embodiments relates to a route guidance method and apparatus for visitors in a venue by using visible light communications.

### BACKGROUND

The statements in this section merely provide background information related to the present disclosure and do not necessarily constitute prior art.

In general, guidance materials are furnished by a variety of event or activity venues such as fairs or museums to provide detailed information of the venues to their visitors. In practice, preparing full individual guidance material takes a lot of effort and expense for the vast customer demographics across different nationalities and age groups.

To counter the deficiency, alternative methods have been proposed, including a method of installing a guidance system adjacent to a displayed object and offering guidance information and a method of offering guidance information though terminals, for example, visitor guidance systems in visitors' possession. Among such proposed methods, the visitor guidance systems are preferably employed by most exhibitions in that they provide a customized guidance service, e.g., guided tour to a visitor with only a simple information update. Meanwhile, most conventional visitor guide information providing systems work on the basis of preset information to offer visitors a uniform recommended route, except for some guidance information providing systems which provide a visitor with a recommended route, reflecting crowdedness and the degree of interest, but still bounded by the visitor's selected exhibits. With the existing visitor guide information providing systems, a visitor may be unwillingly deprived of opportunities to view major exhibits of possible interest to the visitor, temporary exhibits or one-off shows.

### DISCLOSURE

### Technical Problem

Therefore, the present disclosure in some embodiments seeks to provide a route guidance by a route guidance apparatus for visitors in a venue, which generates recommended routes that pass through at least one common point of interest starting from current locations based on a guidance information received from a visible-light illumination device installed in the venue and an information received from an information providing apparatus on a current distribution of the visitors at respective places in the venue, and thereby allowing the visitors to view exhibits more efficiently, while offering a positive guidance for the visitors to view some exhibits or one-off shows which might otherwise be missed out.

### SUMMARY

In accordance with some embodiments of the present disclosure, a route guidance apparatus for visitors in a venue using a visible light communication includes a first communication unit, a second communication unit and an analysis unit. The first communication unit is configured to receive an optical signal from a visible-light illumination device installed in the venue and to extract a guidance information included in the optical signal. The second communication unit is configured to transmit an information on current locations contained in the guidance information to an information providing apparatus and to receive, from the information providing apparatus, an information on a current distribution of the visitors at respective places in the venue through wireless communications. The analysis unit is configured to calculate recommended routes that pass through at least one common point of interest starting from the current locations based on the guidance information and the information on the current distribution and to provide the recommended routes.

In accordance with another embodiment of the present disclosure, an information providing apparatus for calculating routes for visitors in a venue based on information on current locations received from a plurality of route guidance apparatuses for the visitors, includes a communication unit, a distributed information calculation unit, and a route providing unit. The communication unit is configured to respectively receive, from the plurality of route guidance apparatuses, the information on the current locations of the plurality of route guidance apparatuses, collected by communicating with a visible light illumination apparatus. The distributed information calculation unit is configured to calculate an information on a current distribution of the visitors at respective places in the venue based on the information on the current locations of the plurality of route guidance apparatuses, collected by the communication unit. The route providing unit is configured to calculate a recommended route that passes through at least one common point of interest starting from the current location of each of the route guidance apparatuses, based on the information on the current locations of the plurality of route guidance apparatuses and the information on the current distribution and to provide the recommended route.

In accordance with yet another embodiment of the present disclosure, a route guidance method for visitors in a venue by a route guidance apparatus using a visible light communication, includes performing an extraction, performing a reception, and generating recommended routes. The performing of the extraction includes receiving an optical signal from a visible-light illumination device installed in the venue, and extracting a guidance information included in the optical signal. The performing of the reception includes transmitting an information on current locations contained in the guidance information to an information providing apparatus through wireless communications, and receiving, from the information providing apparatus, an information on a current distribution of the visitors at respective places in the venue. The generating of the recommended routes includes calculating recommended routes that pass through at least one common point of interest starting from the current locations based on the guidance information and the information on the current distribution, and providing the recommended routes.

In accordance with yet another embodiment of the present disclosure, a route guidance method for providing recommended routes to visitors in a venue by an information providing apparatus based on an information on current locations received from a plurality of route guidance apparatuses for the visitors, includes respectively receiving, from the plurality of route guidance apparatuses, the information on the current locations of the plurality of route guidance apparatuses, collected by communicating with a visible-light illumination apparatus, generating an information on a current distribution of the visitors at respective places in the venue based on the information on the current locations of the plurality of route guidance apparatuses, and calculating a recommended route that passes through at least one common point of interest starting from the current location of each of the route guidance apparatuses, based on the information on the current locations of the plurality of route guidance apparatuses and the information on the current distribution and providing the recommended route.

### Advantageous Effects

According to the present disclosure as described above, a route guidance apparatus for visitors generates recommended routes that pass through at least one common point of interest starting from current locations based on a guidance information received from a visible-light illumination device installed in the venue and an information received from an information providing apparatus on a current distribution of the visitors at respective places in the venue, and thereby allows the visitors to view exhibits more efficiently, while offering a positive guidance for the visitors to view some exhibits or one-off shows which might otherwise be missed out.

### BRIEF DESCRIPTION OF THE DRAWINGS

FIG. 1 is a schematic block diagram of a route guidance system according to at least one embodiment of the present disclosure.

FIG. 2 is a schematic block diagram of a route guidance apparatus according to at least one embodiment of the present disclosure.

FIG. 3 is a schematic diagram of an information providing apparatus according to at least one embodiment of the present disclosure.

FIG. 4 is a flowchart of a route guidance method for visitors in a venue by a route guidance apparatus using a visible light communication, according to at least one embodiment of the present disclosure.

FIG. 5 is a flowchart of a route guidance method for providing routes to visitors in a venue by an information providing apparatus, according to at least one embodiment of the present disclosure.

FIG. 6 is a flowchart of a route guidance method for providing routes to visitors in a venue by a route guidance apparatus, according to at least one embodiment of the present disclosure.

FIG. 7 is an exemplary diagram for illustrating the implementation of a route guidance apparatus according to at least one embodiment of the present disclosure.

REFERENCE NUMERALS

| | |
|---|---|
| 100: visible-light illumination device | 110: route guidance apparatus |
| 120: information providing apparatus | 210: first communication unit |
| 220: second communication unit | 230: user interface unit |
| 240: analysis unit | 250: output unit |
| 310: communication unit | |

320: distributed information generating unit

| | |
|---|---|
| 330: storage unit | 340: route providing unit |

### DETAILED DESCRIPTION

Hereinafter, at least one embodiment of the present disclosure will be described in detail with reference to the accompanying drawings.

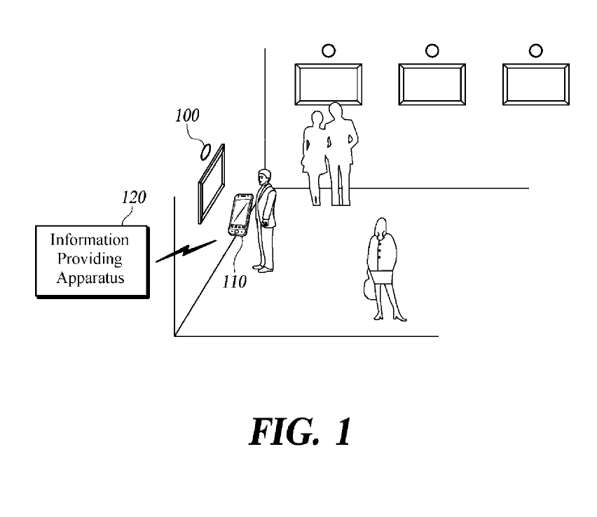

FIG. 1 is a schematic block diagram of a route guidance system according to at least one embodiment of the present disclosure. The route guidance system according to some embodiments is illustrated as being implemented in an exhibition venue such as a fair or museum to provide a route guidance service by using the visible light communication for enabling visitors to view the exhibits more efficiently.

The route guidance system illustrated in FIG. 1 includes a visible-light illumination device 100, a route guidance apparatus 110 and an information providing apparatus 120. Here, the route guidance system is not necessarily limited to include the above components. For example, the visible-light illumination device 100 in the route guidance system may be replaced by a tag information providing apparatus that utilizes RFID technology.

The visible-light illumination device 100 transmits light at visible light wavelength carrying a guidance information to the route guidance apparatus 110. When recognizing the route guidance apparatus 110 within a visible light communication area, the visible-light illumination device 100 transmits by visible light communications, an optical signal including the guidance information to the route guidance apparatus 110. The visible-light illumination device 100 is preferably, but not exclusively, implemented by an LED (Light Emitting Diode). Visible light communications are a technology that utilizes light of illumination by a semiconductor light emitter such as an LED, as a light source for data communication. Light used for the visible light communications is the visible light having 780 nm to 380 nm wavelengths, which is advantageously characterized by the capability of performing communications and illumination at the same time. The illuminating light for use with the visible light communications has a number of advantages that it is harmless to human body and obviates the need to receive spectrum licenses unlike a communication method using various conventional electromagnetic waves.

The visible-light illumination device 100 includes a guidance information input device (not shown) linked thereto for applying a signal containing a guidance information to the visible-light illumination device 100. Specifically, the guidance information input device may be installed in a power supply line which supplies the electric power for light emission, and it applies a signal containing a guidance information to the electric power to be supplied to the visible-light illumination device 100. The guidance information input device is wired to or wirelessly coupled to an external server, and it receives, from the external server, the guidance information to be provided to the route guidance apparatus 110 by using the visible-light illumination device 100. Meanwhile, the guidance information includes at least one of current location information, interior information on the venue where the route guidance system is implemented, and information on the exhibits corresponding to the current location information. Here, the current location information is provided on the basis of the installation coordinates of the visible-light illumination device 100 that interworks with the route guidance apparatus 110, and it may contain information on the name and coordinates of the place where the visitor is currently at among other locations in the venue. The venue interior information may contain at least location information of the respective places inside of the venue and route information of routes running from the current place to the respective places. The information on the exhibits corresponding to the current location information may include additional descriptions of the authors of the exhibits at the current location, their production years, etc. In some embodiments, the additional information in the information on the exhibits is not limited to specific information and it may contain any information relevant to the exhibitions.

The route guidance apparatus 110 is adapted to use the visible light communication for providing a route guidance service for the visitor to the venue. The route guidance apparatus 110 according to some embodiments generates recommended routes that pass through at least one common point of interest starting from the current locations based on a guidance information received from the visible-light illumination device 100 installed in the venue and a current distribution information received from the information providing apparatus 120 on a current distribution of the visitors at respective places in the venue. In other words, the route guidance apparatus 110 according to some embodiments receives the optical signal from the visible-light illumination device 100 installed in the venue, and extracts the guidance information contained in the optical signal. The route guidance apparatus 110 wirelessly transmits the current location information contained in the extracted guidance information to the information providing apparatus 120, and receives, from the information providing apparatus 120, the current distribution information of the visitors at respective places in the venue. The visitors' current distribution information, which represents the numbers of visitors currently located at respective venue locations, is calculated by the information providing apparatus 120 based on the current location information transmitted respectively from route guidance apparatuses possessed by a plurality of visitors inside of the venue. Then, the route guidance apparatus 110 can generate the recommended routes that pass through at least one common point of interest starting from the current locations based on a guidance information received from the visible-light illumination device 100 and the current distribution information received from the information providing apparatus 120 on the visitors at respective venue places. The following will describe a method for the route guidance apparatus 110 to calculate the recommended routes for the visitors inside of the venue.

Based on the current visitor distribution information, the route guidance apparatus 110 determines primary-screened places where the numbers of the visitors exceed a predetermined threshold among the respective places in the venue, and determines, among the primary-screened places, the places identified to have displayed exhibits as common points of interest. It is typical that an exhibition place holds an anchor exhibit representing the exhibition place, which is a destination for most visitors thereto. Furthermore, an uninformed visitor to the exhibition place would be herded naturally towards the anchor exhibit. This crowding of visitors is not only applicable to the anchor exhibit but also to special performances intended for visitors to the exhibition. The route guidance apparatus 110 according to some embodiments calculates the recommended routes for the visitors, taking account of such a characteristic of the crowding of visitors. In other words, the route guidance apparatus 110 analyzes the current distribution information to identify the places where the visitors currently outnumber a predetermined threshold among the respective places in the venue, whereby the route guidance apparatus 110 can generate the places where the numbers of the visitors exceed the predetermined threshold as the primary-screened places. In this case, the predetermined threshold used as a reference for the route guidance apparatus 110 to calculate the primary-screened places is determined by the size of the venue and the average number of visitors to the venue. The route guidance apparatus 110 according to some embodiments is adapted to calculate the places concentrated with visitors as the primary-screened places, taking account of the event of the crowding of visitors, in order to constantly offer a positive guidance for the visitors to view an anchor exhibit which might otherwise be missed out.

Subsequently, the route guidance apparatus 110 utilizes the guidance information received from the visible-light illumination device 100 to determine, among the primary-screened places, the places identified to have displayed exhibits as common points of interest that the visitors in the premises are supposed to stop by. In other words, the route guidance apparatus 110 determines that it is intentional activities of the visitors that they congregate at the primary-screened place displaying a specific exhibit and therefore the route guidance apparatus 110 calculates that place as a common point of interest. Meanwhile, the route guidance apparatus 110 may collect information about performances of the day in the venue from the information providing apparatus 120, and then determine, among the primary-screened places, the active places of performance as the common points of interest.

If the number of the determined common points of interest is equal to or greater than a predetermined amount, the route guidance apparatus 110 selectively filters the common points of interest based on at least one of previous collections of information on the identifications of the visitors, information on the degrees of interest of the visitors, information on congestions of the respective places in the venue, and information on the durations of visits. In this way, the route guidance apparatus 110 according to some embodiments can assist the visitors to browse the exhibits of their interest more efficiently in a scheduled time window. Similarly, the maximum threshold of the common points of interest is determined in accordance with the size of the venue and the average number of visitors to the venue.

The route guidance apparatus 110 generates recommended routes that pass through at least one common point of interest starting from the visitors' current locations based on a guidance information received from the visible-light illumination device 100 and the calculated common point of interest. At this time, the route guidance apparatus 110 receives, from the information providing apparatus 120, the route history information of other visitors who passed through the common point of interest, and further uses the same to calculate the recommended route. On the other hand, the route guidance apparatus 110 may also calculate the recommended route by reflecting additional opinions of visitors. For example, upon receiving information on a user selection of on at least one specific exhibit in the venue from the user interacting with a user interface provided in the route guidance apparatus 110, the route guidance apparatus 110 may generate a recommended route that passes through the viewing place of the exhibit corresponding to the information on the user selection as well as the common point of interest. On the other hand, in response to multiple receptions of the information on the user selection, the route guidance apparatus 110 calculates overlapping select places among those corresponding to the respective information on the user selection. Thereafter, the route guidance apparatus 110 preferentially calculates the recommended route that goes through the calculated select places. If the number of the select places is equal to or less than a predetermined amount, the route guidance apparatus 110 may generate a recommended route that passes through further viewing places corresponding to the common point of interest, among remaining places excluding the select places. At this time, the multiple selection information received by the route guidance apparatus 110 may be information on selections of the respective visitors with their route guidance apparatuses 110, and they may include information on selections by other visitors who accompanied the visitors with their route guidance apparatuses 110. In this case, the route guidance apparatus 110 may perform communications with the route guidance apparatuses 110 in the other visitors' possession, to receive the other visitors' selection information. Similarly, the minimum threshold for the selected places is determined in accordance with the size of the venue and the average number of visitors to the venue.

The route guidance apparatus 110 is described in some embodiments as calculating the recommended route directly based on the information received from the information providing apparatus 120, which however is not limited thereto. For example, the route guidance apparatus 110 may transmit the current location information of the route guidance apparatuses 110 to the information providing apparatus 120, and may receive, from the information providing apparatus 120, a supply of the recommended route which has been calculated based on the current location information of the route guidance apparatuses 110.

The information providing device 120 performs wireless communications with the route guidance apparatus 110, and thereby sends to and receives from, the route guidance apparatus 110, requisite information for calculating the recommended route. For example, when the recommended route is calculated by the route guidance apparatus 110, the information providing apparatus 120 according to some embodiments transmits information on a current distribution of the visitors at respective places in the venue to the route guidance apparatus 110. On the other hand, the information providing apparatus 120 performs communications respectively with the route guidance apparatuses held by a plurality of visitors inside of the venue to receive the current location information of the respective route guidance apparatuses, and thereby calculates the information on the current distribution of the visitors at respective places in the venue. Further, in response to a request of the route guidance apparatus 110, the information providing device 120 may transmit thereto information including the venue information and the route history information for each visitor, which is calculated through continued sharing of information with the plurality of route guidance apparatuses.

According to some embodiments, as an alternative to transmitting the requisite information for the route guidance apparatus 110 to calculate the recommended route, the information providing apparatus 120 may directly calculate the recommended route and provide the same to the route guidance apparatus 110. The following describes a method performed by the information providing apparatus 120 according to some embodiments for calculating the route for the visitors.

The information providing device 120 receives, respectively from a plurality of route guidance apparatuses within the venue, their current location information collected through communicating with the visible-light illumination device 100.

Based on the current location information collected respectively from the plurality of route guidance apparatuses, the information providing device 120 calculates information on the current distribution of the visitors at respective places in the venue.

The information providing device 120 is adapted to calculate a recommended route that passes through at least one common point of interest starting from the current location of each of the route guidance apparatuses, based on the information on the current locations of the plurality of route guidance apparatuses and the information on the current distribution of the visitors at respective places in the venue, and to provide the recommended route. Thereafter, the information providing apparatus 120 provides the calculated recommended route to the corresponding route guide apparatuses, respectively. On the other hand, the procedure for the information providing apparatus 120 to calculate the recommended route for the visitors based on the information on the current locations of the plurality of route guidance apparatuses and the information on the current distribution of the visitors will not be detailed further not to repeat the above description of the method for the route guidance apparatus 110 to calculate the recommended routes based on a guidance information and the current distribution information.

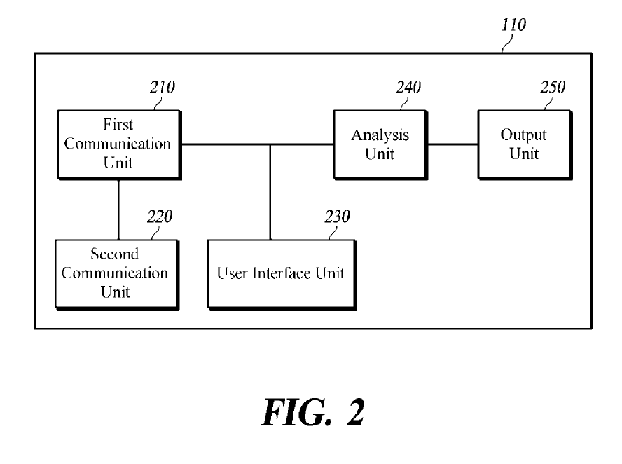

FIG. 2 is a schematic block diagram of a route guidance apparatus according to at least one embodiment of the present disclosure.

As shown in FIG. 2, the route guidance apparatus 110 according to some embodiments includes a first communication unit 210, a second communication unit 220, a user interface unit 230, an analysis unit 240 and an output unit 250.

The first communication unit 210 receives an optical signal from the visible-light illumination apparatus 100 installed in the venue, and extracts and provides a guidance information included in the optical signal. In other words, the first communication unit 210 is provided with a means, such as an optical sensor, capable of detecting an optical signal, analyzes a guidance information included in the optical signal received with the optical sensor, and processes the guidance information, and provides the same as an identifiable information. At this time, the guidance information includes at least one of the current location information, the interior information on the venue where the route guidance system is implemented, and the information on the exhibits corresponding to the current location information.

The second communication unit 220 is provided with a means for wireless communication, and it performs wireless communications with the information providing apparatus 120 to send and receive the necessary information for calculating the recommended route. Specifically, the second communication unit 220 sends the current location information included in the guidance information to the information providing apparatus 120, and receives the information on the current distribution of the visitors at respective places in the venue from the information providing apparatus 120. Here, the current distribution information of the visitors is calculated by the information providing apparatus 120 based on respective transmissions of the current location information from the route guidance apparatuses held by a plurality of visitors within the venue. The current distribution information of the visitors refers to the numbers of visitors currently located at respective venue locations. On the other hand, when the recommended route is calculated by the information providing device 120, the second communication unit 220 is provided with the calculated recommended route from the information providing device 120.

The user interface unit 230 receives, from the user holding the route guidance apparatus 110, the user's selection information used as a reference for calculating the recommended route. In other words, the user interface unit 230 receives the user's selection information about at least one specific exhibit in the venue from the user through a touch screen, a keypad, voice and the like, and relays that information to the analysis unit 240.

The analysis unit 240 generates recommended routes that pass through at least one common point of interest starting from the current locations based on the guidance information received by using the first communication unit 210 and the information on the current distribution of the visitors at respective places in the venue, which is received by using the second communication unit 220.

The following describes a method performed by the analysis unit 240 for generating the recommended routes for the visitors based on the guidance information received through the first communication unit 210 and the current visitor distribution information received through the second communication unit 220.

The analysis unit 240 analyzes the current distribution information of visitors to determine, among other respective places in the venue, places where the number of current visitors exceeds a predetermined threshold, and then generates the threshold-exceeding places as primary-screened places.

By using guidance information received via the first communication unit 210, the analysis unit 240 determines, among the primary-screened places, the places identified to have displayed exhibits as common points of interest that the visitors to the venue are supposed to stop by. Meanwhile, the analysis unit 240 may collect information about performances of the day in the venue from the information providing apparatus 120, and then determine, among the primary-screened places, the active places of performance as the common points of interest.

If the number of the determined common points of interest is equal to or greater than a predetermined amount, the analysis unit 240 selectively filters the common points of interest based on at least one of previous collections of information on the identifications of the visitors, information on the degrees of interest of the visitors, information on congestions of the respective places in the venue, and information on the durations of visits.

Based on the guidance information received via the first communication unit 210 and the previously calculated common points of interest, the analysis unit 240 generates recommended routes that pass through at least one of the common points of interest starting from the visitors' current locations. At this time, the analysis unit 240 receives, from the information providing apparatus 120, route history information of other visitors who passed through the common point of interest, and further uses the same to calculate the recommended route.

Upon receiving information on a user selection of at least one specific exhibit in the venue from the user through the user interface unit 230, the analysis unit 240 generates a recommended route that passes through the viewing place of the exhibit corresponding to the information on the user selection as well as the common point of interest.

In response to multiple receptions of the information on the user selection, the analysis unit 240 calculates overlapping select places among those corresponding to the respective information on the user selection. Thereafter, the analysis unit 240 preferentially calculates the recommended route that goes through the calculated select places. However, if the number of the select places is equal to or less than a predetermined amount, the analysis unit 240 generates a recommended route that further passes through the viewing places corresponding to common points of interest, among other places than the select places. At this time, the multiple selection information received by the analysis unit 240 may be information on selections of the visitors with their respective route guidance apparatuses 110, and they may include information on selections by other visitors who accompanied the visitors with their route guidance apparatuses 110.

The output unit 250 outputs the recommended route calculated by the analysis unit 240 or the guidance information in a user-perceptible form. To this end, the output unit 250 may output the recommended route or the guidance information in the form of sound, video and the like. The method of outputting the recommended route or guidance information is not limited to a particular scheme by the present embodiment.

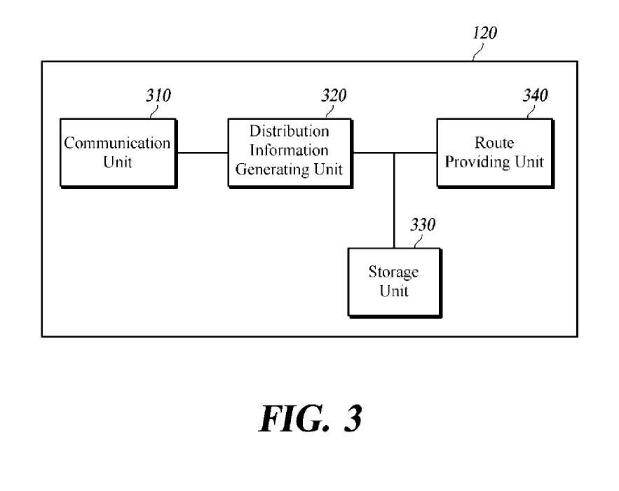

FIG. 3 is a schematic diagram of an information providing apparatus according to at least one embodiment of the present disclosure.

As shown in FIG. 3, the information providing apparatus 102 according to some embodiments includes a communication unit 310, a distribution information generating unit 320, a storage unit 330 and a route providing unit 340.

The communication unit 310 communicates wirelessly with the route guidance apparatus 110, and thereby sends to and receives from, the route guidance apparatus 110, requisite information for calculating the recommended route. For example, when the recommended route is calculated by the route guidance apparatus 110, the communication unit 310 according to some embodiments transmits, from the distribution information generating unit 320, its generated information on the current distribution of the visitors at respective venue places to the route guidance apparatus 110. In response to a request of the route guidance apparatus 110, the communication unit 310 may transmit thereto further information including the venue information and the route history information for each visitor, which is calculated through constant sharing of information with the plurality of route guidance apparatuses. Further, when the recommended route according to some embodiments is calculated by the information providing apparatus 120, the communication unit 310 receives, from the route guidance apparatus 110, its current location information of the collected through communications with the visible-light illumination device 100 and subsequently, on the other hand, the communication unit 310 utilizes the current location information of the route guidance apparatus 110 so as to transmit thereto a recommended route calculated by the route providing unit 340.

The distribution information generating unit 320 receives the current location information of the route guidance apparatuses held by a plurality of visitors inside of the venue through the communication unit 310, and it calculates the information on the current distribution of the visitors at respective places in the venue based on the collected current location information of the respective route guidance apparatuses.

The storage unit 330 stores requisite information required in the process of calculating the recommended routes for the visitors in the venue. Specifically, the storage unit 330 stores principal venue information including a visit duration, and on the other hand, stores other information, e.g., current locations transmitted from the plurality of route guidance apparatuses in the venue. The storage unit 330 constantly stores the transmitted information from the plurality of route guidance apparatuses, and thereby it can further store calculated route history information for each of the visitors.

The route providing unit 340 generates a recommended route that passes through at least one common point of interest starting from a current location of each of the route guidance apparatuses, based on the information on the current locations of the plurality of route guidance apparatuses, collected through the communication unit 310 and the current distribution information of the visitors at respective places in the venue, calculated by the distribution information generating unit 320. The method performed by the route providing unit 340 for calculating the recommended route for the visitors based on the information on the current locations of the plurality of route guidance apparatuses and the information on the current distribution of the visitors, will not be repeated because it is the same as the above description of the method performed by the analysis unit 240 included in the route guidance apparatus 110 for calculating the recommended routes based on a guidance information and the current distribution information.

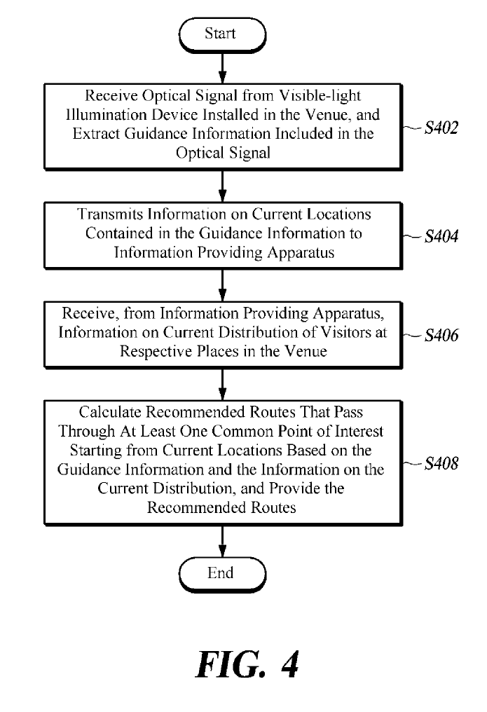

FIG. 4 is a flowchart of a method for providing route guidance for visitors in a venue by a route guidance apparatus using visible light communication, according to at least one embodiment of the present disclosure.

The route guidance method performed by the route guidance device 110 by utilizing the visible light communication according to some embodiments starts with the route guidance apparatus 110 receiving an optical signal from a visible-light illumination device 100 installed in the venue, and extracting a guidance information included in the optical signal (Step S402). The guidance information extracted in Step S402 includes at least one of the current location information, the interior information on the venue where the route guidance system is implemented, and the information on the exhibits corresponding to the current location information.

The route guidance apparatus 110 transmits an information on current locations contained in the guidance information to the information providing apparatus 120 (S404), and receives, from the information providing apparatus 120, an information on a current distribution of the visitors at respective places in the venue (S406). Before the route guidance apparatus 110 receives the current distribution information of the visitors at respective places in the venue from the information providing apparatus 120, the latter calculates the current distribution information based on respectively transmitted current location information from multiples of the route guidance apparatus held by a plurality of visitors within the venue.

Based on the guidance information extracted in Step S402 and the information on the current visitor distribution received in Step S406, the route guidance apparatus 110 calculates recommended routes that pass through at least one common point of interest starting from the current locations of the visitors, and provides the recommended routes (S408). In Step S408, based on the current visitor distribution information received in Step S406, the route guidance apparatus 110 determines primary-screened places where the numbers of the visitors exceed a predetermined threshold among the respective places in the venue, and determines, among the primary-screened places, the places identified to have displayed exhibits as common points of interest.

Here, Steps S402 through S408 respectively correspond to the operations of the first communication unit 210, second communication unit 210 and analysis unit 240 of the route guidance apparatus 110, and their description will not be repeated.

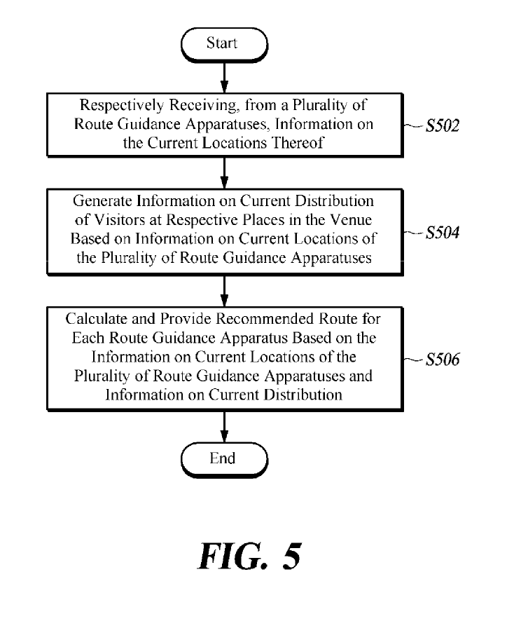

FIG. 5 is a flowchart of a route guidance method performed by an information providing apparatus for providing routes to visitors in a venue, according to at least one embodiment of the present disclosure.

The method according to at least one embodiment for the information providing apparatus 102 to provide routes to visitors in a venue starts with respectively receiving, from a plurality of route guidance apparatuses located in the venue, information on the current locations of the plurality of route guidance apparatuses, collected by communicating with the visible-light illumination apparatus 100 (S502).

The information providing device 120 generates information on a current distribution of the visitors at respective places in the venue based on the information on the current locations of the plurality of route guidance apparatuses, respectively collected from the plurality of route guidance apparatuses (S504).

Based on the information collected in Step S502 on the current locations of the plurality of route guidance apparatuses and the information generated in Step S504 on the current distribution of the visitors at respective places in the venue, the information providing device 120 calculates a recommended route that passes through at least one common point of interest starting from a current location of each of the route guidance apparatuses, and provides the recommended route (S506).

Here, Steps S502 through S506 respectively correspond to the operations of the communication unit 310, distribution information generating unit 320 and route providing unit 340 of the route guidance apparatus 110, and their description will not be repeated.

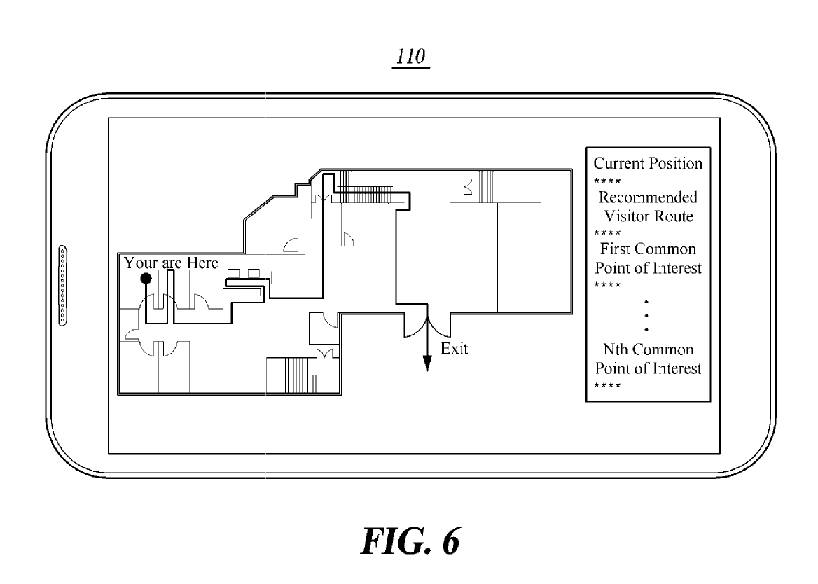

FIG. 6 is a flowchart of a route guidance method performed by a route guidance apparatus for providing routes to visitors in a venue, according to at least one embodiment of the present disclosure.

As shown in FIG. 6, the route guidance apparatus 110 according to the present embodiment calculates recommended routes that pass through at least one common point of interest starting from current locations based on a guidance information and an information on a current distribution of the visitors at respective places in the venue, and provides the calculated recommended routes as applied to a predetermined UI (user interface). Further, the route guidance apparatus 110 may provide addition information on the common points of interest selected in the process of calculating the current locations of the visitors and their recommended routes, and addition information on the exhibits located at the common points of interest. The route guide apparatus 110 according to some embodiments generates recommended routes that pass through at least one common point of interest starting from current locations based on a guidance information received from a visible-light illumination device installed in the venue and an information received from the information providing apparatus 120 on a current distribution of the visitors at respective places in the venue, and thereby allowing the visitors to view exhibits more efficiently, while offering a positive guidance for the visitors to view some exhibits or one-off shows which might otherwise be missed out.

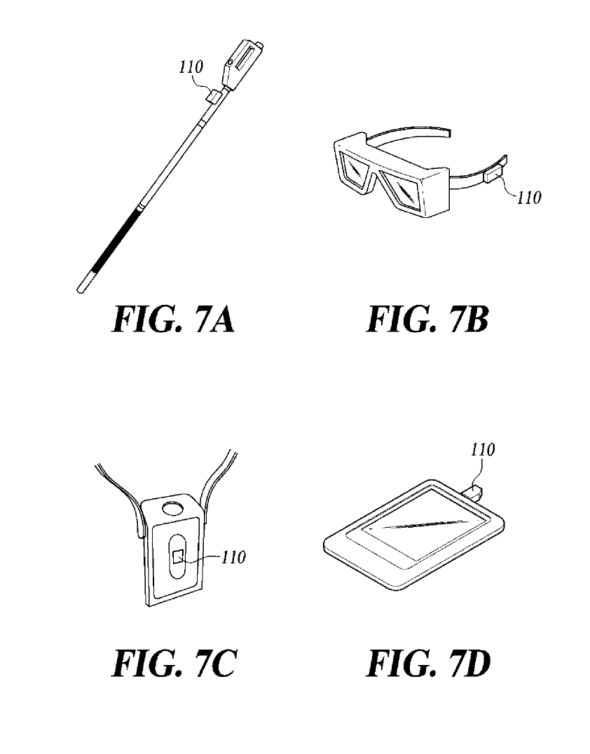

FIG. 7 is an exemplary diagram illustrating the implementation of a route guidance apparatus according to at least one embodiment of the present disclosure.

As shown in FIG. 7 from (a) to (d), the route guidance apparatus 110 according to the present embodiment may be implemented by various articles including, but not limited to, a cane, eyeglasses, identification and terminal held by a visitor. For example, the route guidance apparatus 110 according to the present embodiment is implemented into any attachable form of belongings as long as they can be carried by visitors on the move.

Although exemplary embodiments of the present disclosure have been described for illustrative purposes, those skilled in the art will appreciate that various modifications, additions and substitutions are possible, without departing from the idea and scope of the claimed invention. Such exemplary embodiments of the present disclosure have been described for the sake of brevity and clarity. Accordingly, one of ordinary skill would understand the scope of the claimed invention is not to be limited by the explicitly described embodiments as above but by the claims and equivalents thereof.

### CROSS-REFERENCE TO RELATED APPLICATION

This application claims priority under 35 U.S.C §119(a) of Patent Application No. 10-2014-0122285, filed on Sep. 15, 2014 in Korea, the entire content of which is incorporated herein by reference. In addition, this non-provisional application claims priority in countries, other than the U.S., with the same reason based on the Korean patent application, the entire content of which is hereby incorporated by reference.

1. A route guidance apparatus for visitors in a venue using a visible light communication, the route guidance apparatus comprising:
a first communication unit configured to receive an optical signal from a visible-light illumination device installed in the venue and to extract a guidance information included in the optical signal;
a second communication unit configured to transmit an information on current locations contained in the guidance information to an information providing apparatus and to receive, from the information providing apparatus, an information on a current distribution of the visitors at respective places in the venue through wireless communications; and
an analysis unit configured to calculate recommended routes that pass through one or more common points of interest starting from the current locations based on the guidance information and the information on the current distribution and to provide the recommended routes.

2. The route guidance apparatus of claim 1, wherein the guidance information includes at least one of a current location information, interior information on the venue, and an information on exhibits corresponding to the current location information.

3. The route guidance apparatus of claim 1, wherein the current distribution information is calculated based on respectively current location information transmitted from multiples of the route guidance apparatus held by a plurality of visitors within the venue.

4. The route guidance apparatus of claim 1, wherein the analysis unit determines, based on the information on the current distribution of the visitors, primary-screened places where numbers of the visitors exceed a predetermined threshold among the respective places in the venue, and determines, among the primary-screened places, places identified to have displayed exhibits as the common points of interest.

5. The route guidance apparatus of claim 4, wherein, if the number of the common points of interest is equal to or greater than a predetermined amount, the analysis unit selectively filters the common points of interest based on at least one of an information on identifications of the visitors, an information on degrees of interest of the visitors, an information on congestions of the respective places in the venue, and an information on durations of visits.

6. The route guidance apparatus of claim 1, wherein upon receiving an information on a user selection of at least one specific exhibit in the venue, the analysis unit generates a recommended route that passes through a viewing place of the exhibit corresponding to the information on the user selection and through the common point of interest.

7. The route guidance apparatus of claim 6, wherein in response to multiple receptions of the information on the user selection, the analysis unit preferentially calculates a recommended route that goes through select places that overlap among viewing places corresponding to the respective information on the user selection, and if the number of the select places is equal to or less than a predetermined amount, the analysis unit generates a recommended route that passes through further viewing places corresponding to the common point of interest, among remaining places excluding the select places.

8. The route guidance apparatus of claim 1, wherein the analysis unit receives, from the information providing apparatus, a route history information of other visitors who passed through the common point of interest, and further uses the route history information to calculate the recommended route.

9. An information providing apparatus for calculating routes for visitors in a venue based on an information on current locations received from a plurality of route guidance apparatuses for the visitors, the information providing apparatus comprising:
a communication unit configured to respectively receive, from the plurality of route guidance apparatuses, the information on the current locations of the plurality of route guidance apparatuses, collected by communication between the route guidance apparatuses and visible light illumination apparatus;
a distributed information calculation unit configured to calculate an information on a current distribution of the visitors at respective places in the venue based on the information on the current locations of the plurality of route guidance apparatuses, collected by the communication unit; and
a route providing unit configured to generate a recommended route that passes through one or more common point of interest starting from a current location of each of the route guidance apparatuses, based on the information on the current locations of the plurality of route guidance apparatuses and the information on the current distribution.

10. The information providing apparatus of claim 9, wherein the route providing unit determines, based on the information on the current distribution of the visitors, primary-screened places where numbers of the visitors exceed a predetermined threshold among the respective places in the venue, and determines, among the primary-screened places, places identified to have displayed exhibits as the common points of interest.

11. The information providing apparatus of claim 9, wherein upon receiving, from the plurality of route guidance apparatuses, an information on a user selection of at least one specific exhibit in the venue, the route providing unit generates a recommended route that passes through a viewing place of the exhibit corresponding to the information on the user selection and through the common point of interest.

12. A route guidance method for visitors in a venue by a route guidance apparatus using a visible light communication, the route guidance method comprising:
receiving an optical signal from a visible-light illumination device installed in the venue, and extracting a guidance information included in the optical signal;
transmitting an information on current locations contained in the guidance information to an information providing apparatus through wireless communications, and receiving, from the information providing apparatus, an information on a current distribution of the visitors at respective places in the venue; and
calculating recommended routes that pass through at least one common point of interest starting from the current locations based on the guidance information and the information on the current distribution, and providing the recommended routes.

13. A route guidance method for providing routes to visitors in a venue by an information providing apparatus based on an information on current locations received from a plurality of route guidance apparatuses for the visitors, the route guidance method comprising:
respectively receiving, from the plurality of route guidance apparatuses, the information on the current locations of the plurality of route guidance apparatuses, collected by communication between the plurality of route guidance apparatuses and a visible-light illumination apparatus;
generating an information on a current distribution of the visitors at respective places in the venue based on the information on the current locations of the plurality of route guidance apparatuses; and
calculating a recommended route that passes through at least one common point of interest starting from a current location of each of the route guidance apparatuses, based on the information on the current locations of the plurality of route guidance apparatuses and the information on the current distribution and providing the recommended route.
